(19) United States
(12) Patent Application Publication
(10) Pub. No.: US 2005/0071754 A1
(43) Pub. Date: Mar. 31, 2005

(54) Pushing information to distributed display screens

(76) Inventors: Daivid J. Morgan, Newbury (IE); Benjamin A. Briggs, Dallas, TX (US)

Correspondence Address: FISH & RICHARDSON P.C., 1425 K STREET, N.W., 11TH FLOOR, WASHINGTON, DC, 20005-3500, US

(21) Appl. No.: 10/675,593

(22) Filed: Sep. 30, 2003

(51) Int. Cl. G06F 15/00

(52) U.S. Cl. 715/511

(57) ABSTRACT

Techniques for displaying information on a set of displays include identifying a change in data displayed by a client and notifying the client of a change to the displayed data. In response to the notification, a request for a page containing the changed data is received, and a page containing the changed data is generated. The page may be stored for retrieval by other clients that subsequently request the same page. The page containing the changed data is then sent to the client for display. The client continues to retrieve and display the same page from a local cache until being notified of another change to the data displayed on the page.

### TECHNICAL FIELD

This description relates to a system for displaying information on multiple screens, in particular to pushing data regarding changes of the displayed information to remote screens.

### BACKGROUND

Enterprises must communicate to the public, and displaying crucial information on computer monitors is a good way to do so. The large amount of information going to a large audience requires a display system with many screens. These screens and the controlling architecture may be distributed over a wide geographical area, making maintenance and deployment of the system expensive. If the screens display static pages that rarely or never change, distribution may require only modest resources. If the screens display dynamic pages that change frequently or constantly, it is generally necessary to reload the page every time it is displayed. Each call to retrieve a dynamic page results in a large data transfer over the full radius of the network. Thus, to distribute information that is constantly or periodically changing to the geographically scattered screens requires a thick network pipeline and powerful servers, which are very expensive.

### SUMMARY

Techniques are described for efficiently managing a display of information in a distributed display environment. The inventors recognized that, by initiating page refreshes from a server side rather than having a client constantly reloading a page, pages to be displayed in a distributed web-based display environment only need to be updated when the information on the page changes. In a typical browser-based system, a client device contains a cache of recently loaded pages. If a page is to be displayed, the client device has no way to determine whether to use a previously cached version of the page or to reload the page from the remote server because the client device does not know if the page's information has changed. If a screen rotates between several pages consecutively, each time a page comes up in the rotation, the page may need to be completely reloaded in case the information on the page has changed.

By effectively delivering pages “upstream” (i.e., in the direction from a data repository or server to a client), constant reloading of pages may be significantly reduced. Such an upstream delivery may be implemented by identifying, at a central server, event triggers that indicate that certain data have changed. The server may manage the various available pages and may be aware of which pages contain the changed data. Accordingly, the server may be able to create a new version of pages that have changed and save the changed pages (e.g., as a static HTML file for delivery to clients by a web server). The central server may also have the ability to manage clients (e.g., display screens), enabling the central server to notify those screens that are displaying the changed pages. In response to such a notification, the display screens may then request the new pages, which, in addition to being displayed, may be loaded into a local cache and/or onto a network cache for use by nearby display screens. As each display screen rotates through a set of pages, the display screen may repeatedly display the cached version of the page, rather than requesting the page from the central server and requiring the page to be recreated from underlying data that defines page's layout and content.

In one general aspect, information is displayed on a set of displays by identifying a change in data displayed by a set of clients and notifying the set of clients of a change to the displayed data. In response to the notification, a request for a page containing the changed data is received, and a page containing the changed data is generated. The page containing the changed data is sent to the set of clients.

Implementations may include one or more of the following features. For example, each client may be assigned a rotation set including a list that identifies pages to be displayed by the client. The page that contains the changed data, one or more rotation sets that identify the page containing the changed data, and one or more clients that display the identified rotation sets may be identified. The rotation set may specify a uniform resource locator for one or more pages to be displayed by the client to which the rotation set is assigned. The rotation set may specify an amount of time for which the one or more pages are to be displayed by the client to which the rotation set is assigned. Notifying a set of clients of the change to the displayed data may involve sending one or more rotation sets to the set of clients, with the pages identified by the rotation sets reflecting the change in the displayed data. The rotation set may be sent to the set of clients in response to identifying the change in the displayed data. Hypertext transfer protocol (HTTP) may be used to send the rotation sets.

Instructions for each client to request pages that contain changed data in response to receiving a rotation set may be sent to the set of clients. Instructions for each client to display the pages identified by a received rotation set at least until the client receives a new rotation set may be sent to the set of clients. The instructions may be in the form of portable, platform independent code. Each page may include multiple panels and identifying the page that contains the changed data may include identifying a panel that contains the changed data and identifying the page that contains the identified panel. The panel that contains the changed data and the page that contains the identified panel may be identified using XML code. The rotation sets may be defined in an extensible markup language (XML) document. The page that contains the changed data, the rotation sets that identify the page containing the changed data, and the client that displays the identified rotation sets may also be identified using XML code.

Identifying a change in the displayed data may involve receiving an indication of the change in the displayed data. The page containing the changed data may be stored for access by a plurality of different displays. The page containing the changed data may include multiple panels. One or more panels that contain the changed data and one or more pages that contain the identified panels may be identified. Generating the page containing the changed data may involve defining the page using hypertext markup language (HTML). The page containing the changed data may be retrieved from a cache in response to receiving the request if the page containing the changed data was generated in response to a previously received request for the page containing the changed data.

The page containing the changed data may include multiple panels. One or more panels that contain the changed data may be identified, and the changed data may be retrieved. Using the changed data, the identified panels may be generated and the page containing the changed data may be generated using the identified panels. One or more panels containing the changed data may be retrieved from a cache in response to receiving the request for a page. Generating the panels containing the changed data may be performed in response to a previously received request for the panels containing the changed data. A name of the page containing the changed data may specify the changed data to be retrieved. The request for a page may comply with the hypertext transfer protocol, and the page containing the changed data may be displayed in a web browser.

A determination may be made if each page identified in a rotation set is stored in a cache associated with a display device to display the rotation set. If so, pages that are stored in the cache may be retrieved and one or more requests may be sent to a remote server for pages that are not stored in the cache. The requested pages may be received in response to the at least one request and may be stored in the cache. Each page may then be retrieved from the cache and displayed in a repeating sequence until a new rotation set is received.

The notification of a change in the data to be displayed may be sent using the open connection with each client. The requested pages may be generated using the changed data and using formatting data defining the content and layout of the pages.

The details of one or more implementations are set forth in the accompanying drawings and the description below. Other features will be apparent from the description and drawings, and from the claims.

### DESCRIPTION OF DRAWINGS

FIG. 1 is a block diagram of a system for displaying information across multiple screens.

FIG. 2 is a flow chart of a process for displaying information on multiple screens.

FIG. 3 is a flow chart of a process for determining the information that a screen displays.

FIG. 4 is a flow chart of a process for retrieving the information to be displayed.

FIG. 5 is a flow chart of a process for formatting the information to be displayed.

Like reference symbols in the various drawings indicate like elements.

### DETAILED DESCRIPTION

Techniques for displaying information across multiple screens may involve multiple screens that are distributed across a network. A central management system may manage the information to be displayed, and the information may be formatted and sent out for display when requested by the screens throughout the system. The system may also identify when information has changed and notify the screens that display the changed information to request the updated information. The system may also centrally manage configuration data that specifies how information is displayed across the system, which avoids the need to perform configuration functions in multiple locations. The configuration data may also be used when formatting the information to be displayed.

Information is displayed by the system as web pages in a web browser program running on the screens throughout the system. The screens may be implemented as a monitor or other display screen connected to a screen controller or processor. In some implementations, multiple display screens may be connected to and controlled by a nearby screen controller. The web pages may be constructed using one or more smaller parts called panels. Each panel may be represented by HTML code that specifies the contents of one piece of the page to be displayed. Each panel contains some of the data to be displayed on the page. The panels may be centrally created and combined to form pages. The pages and/or the individual panels may then be sent to the screens for display.

Each page may belong to a rotation set. A rotation set is a set of one or more pages to be displayed on a single screen. Each page of the rotation set may be displayed for a certain amount of time before the next page in the rotation is loaded and displayed. Typically, after all pages in the rotation set have been displayed, the process starts over with the first page in the rotation set. For example, a common application of a distributed display system is the display of flight information at an airport. Monitors throughout an airport may rotate through displaying departure and/or arrival information. Parts of the rotation may include information about one or more flights departing or arriving at one or more gates that are near a particular monitor. In addition, advertisements or other information may be inserted into the rotation. The screens that are included in the rotation may be defined by a rotation set.

Each rotation set may be specified in an XML document, and each page in the rotation set may be identified by a uniform resource locator (URL) within the XML document. The URL may represent simply a name associated with the page or may provide some information about the contents of the page. There are generally multiple page elements within a single rotation set element, representing the multiple pages within the rotation set. An example of an XML definition of a rotation set is as follows:

```
<rotation-set>
    <page id=“1” delay=“10” url=“page1”>
    <page id=“2” delay=“10” url=“page2”>
    <page id=“3” delay=“10” url=“page3”>
    <page id=“4” delay=“10” url=“page4”>
    <page id=“5” delay=“10” url=“page5”>
    <page id=“6” delay=“3” url=“page6”>
</rotation-set>
```

In this example, each page element contains an “id” attribute that specifies the name of the page in the rotation set, a “delay” attribute that specifies the amount of time for which the page should be displayed, and a “url” attribute that specifies the location from which the page can be retrieved.

As used herein, the terms “electronic document” and “document” mean a set of electronic data, including electronic data stored in a file and electronic data received over a network. An electronic document does not necessarily correspond to a file. An electronic document may be in the form of electronic records in a database, which may provide for faster retrieval. A document may be stored in a portion of a file that holds other documents, in a single file dedicated to the document in question, or in a set of coordinated files. An XML document (or other markup language document) may be simply a snippet of XML code (or other markup language code).

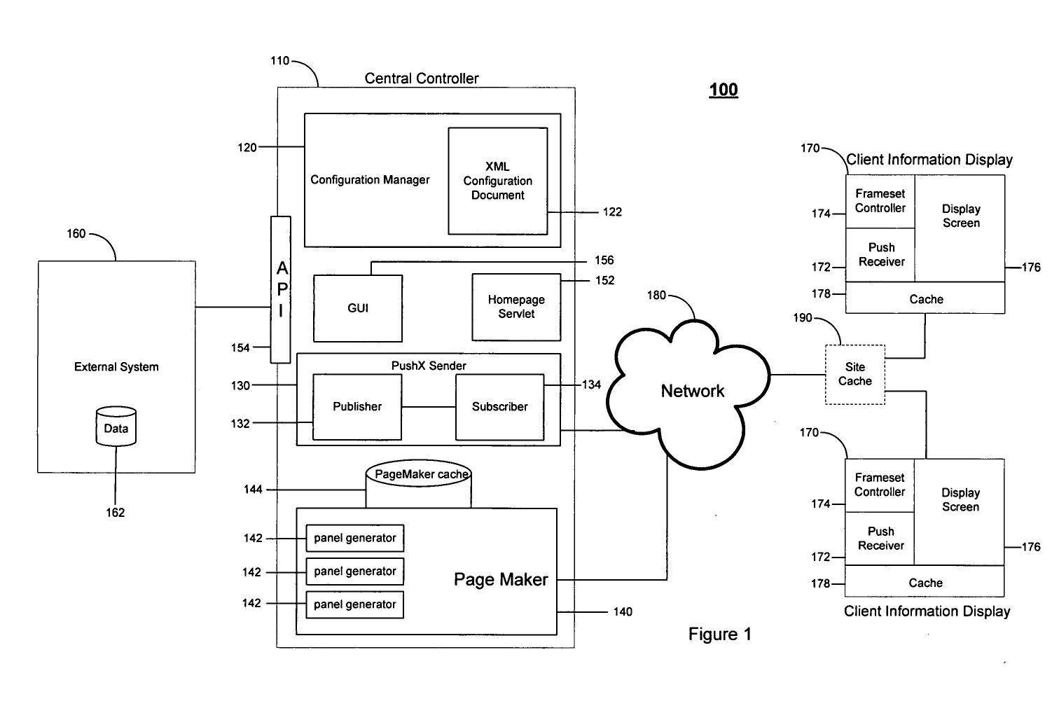

FIG. 1 is a block diagram of an information display system 100 that displays information across multiple screens. The information to be displayed is configured and maintained by a central controller 110 that is connected to an external system 160. The external system 160 generates and stores underlying data 162 from which the information to be displayed is produced. In addition, the central controller 110 includes an application programming interface (API) 154 through which the external system 160 communicates with the central controller 110. Whenever data underlying the display system change, the external system 160 notifies the central controller that certain data have changed through the API 154. The notification from the external system 160 may be in the form of a Java Messaging Service (JMS) message, an XML document or in some other format. The system 100 includes one or more client information displays 170 that display the information maintained by the information display system 100. The client information displays 170 and the central controller 110 are connected through a network 180. In one possible implementation, the central controller 110 may be a server, the external system 160 may be a database or a data management system, and the client information displays 170 may use a browser to display pages.

The central controller 110 includes three major modules: a configuration manager 120, a sender 130, and a page maker 140. The configuration manager 120 is responsible for generating, storing, and maintaining the configuration data for the information display system 100. The configuration data may be stored in one or more XML configuration documents 122, or in any other desired format. The XML configuration documents 122 may specify the information contained on a panel, the panels that are included on a page, the layout of panels within a page, the client information displays 170 that display a page, the rotation sets that may be displayed on the client information displays 170, and the pages in a rotation set. The XML configuration documents 122 also may contain other information regarding the configuration of the information display system 100. The configuration manager 120 may include a processor for reading, parsing, and extracting information from the XML configuration documents 122 to respond to queries about the system configuration, which may be received, for instance, from the page maker 140.

The sender 130 is responsible for notifying the client information displays 170 when the information to be displayed changes. In other words, the sender is responsible for sending each client information display 170 one or more rotation sets associated with the client information display 170. The sender 130 includes a publisher 132 and one subscriber 134 for each client information display 170 in the information display system 100. The publisher 132 receives from the configuration manager 120 the rotation sets to be displayed and the names of the client information displays 170 assigned to display each rotation set. Based on a stored mapping between subscribers 134 and names of client information displays 170, the publisher 132 passes each rotation set to the subscriber 134, which maintains a connection to the client information display 170 that is to display the rotation set. In one possible alternative implementation, the publisher may also store data indicating which client information displays 170 are assigned to display each rotation set. For example, the configuration manager 120 may inform the publisher that a particular rotation set has changed (e.g., rotation set “56”), and the publisher may store information associating the particular rotation set with one or more client information displays 170 and/or the corresponding subscriber 134.

The subscriber 134 sends the rotation set to the corresponding client information display 170. In one possible implementation, the subscriber 134 uses pushlet technology, which is a Java servlet-based technology to push events from a server into DHTML browsers, to maintain a connection with the corresponding client information display 170 and to send an updated rotation set each time a change occurs in the information to be displayed. Other types of software code or mechanisms may also be used to push rotation sets to the client information displays 170 (e.g., including using applets running on the client information display 170). After receiving a rotation set, the client information display 170 uses the page information in the rotation set to request and load the specified pages from the central controller 110. Each page of the rotation set is then displayed by the client information display 170 for the amount of time specified by the rotation set.

The page maker 140 is responsible for responding to requests for pages from the client information displays 170. In general, requests for a specific page may be received in the form of a particular URL. In response to a request, the page maker 140 may create the page using data, which may be stored in the configuration manager 120, regarding the structure and contents of the page. For example, the configuration manager 120 may store data about the structure and contents of the page that corresponds to a particular URL. The page maker 140 obtains the data to be displayed from the external system 160 through the API 154. Communications between the page maker 140 and the external system 160 (e.g., requests for data and responses to such requests) may be in the form of RMI requests, business delegate method calls (a common Java pattern), XML documents or using some other method. Using the data from the external system 160, one or more panel generators 142 in the page maker 140 create the page. The panel generators 142 create the panels using data from the configuration manager 120 regarding the structure and contents of the panel and using the underlying data 162 obtained from the external system 160. The page maker 140 combines the panels created by the panel generators 142 to form the page that is then sent to the client information display 170 that requested the page. The page maker 140 also contains a page maker cache 144 from which pages and panels can be retrieved, when available, instead of constructing the pages and panels from scratch. Recently created pages and panels, for example, are stored in the page maker cache 144. Use of pages and panels from the page maker cache 144, when available, saves the page maker 140 from having to access the external system 160 every time a request for a page is received from the client information displays 170. For example, if a particular page is displayed on a number of different client information displays 170, the page maker 140 may construct the page the first time the page is requested by a client information display 170. Thereafter, each time the page maker 140 receives a request for the same page, the page can be retrieved from the page maker cache instead of reconstructing the page.

In addition to the configuration manager 120, the sender 130, and the page maker 140, the central controller may include modules that perform additional functions. A homepage servlet 152, for example, may send a default home page to the client information displays 170 when the displays 170 initially connect to the system. The client information displays 170 may use a web browser to display the information in the information display system 100. The home page address for the browser on each client information display 170 may be set to an address associated with the home page servlet 152. When the web browser for a client information display 170 is started, the specified home page is requested from the central controller 110. The homepage servlet 152 sends the home page to the client information displays 170 and also keeps track of the client information displays 170 that have requested the home page. The central controller 110 may use the list of client information displays that have requested the home page to determine which client information displays 170 are available to display information. The central controller 110 may also contain a graphical user interface (GUI) 156 that can be used to manually view and edit the XML configuration documents 122, thus altering the behavior of the information display system 100.

The central controller 110 may be implemented using, for example, a general-purpose computer capable of responding to and executing instructions in a defined manner, a personal computer, a special-purpose computer, a workstation, a server, a device, a component, or other equipment or some combination thereof capable of responding to and executing instructions. The central controller 110 may receive instructions from, for example, a software application, a program, a piece of code, a device, a computer, a computer system, or a combination thereof, which independently or collectively direct operations, as described herein. The instructions may include one or more communications programs. For instance, such communications programs may include web browser programs, e-mail programs, IM programs, FTP programs, etc. The instructions may be embodied permanently or temporarily in any type of machine, component, equipment, storage medium, or propagated signal that is capable of being delivered to the central controller 110. In one implementation, the instructions for controlling operation of the central controller 110 may be written in Java using the Java 2 Enterprise Edition (J2EE) architecture.

Further, the central controller 110 may include a communications interface (not shown) used by the communications programs to send communications through the network 180. The communications may include web pages, e-mail, audio data, video data, general binary data, or text data (e.g., encoded in American Standard Code for Information Interchange (ASCII) format). The central controller 110 may also include one or more input devices, such as a keyboard, mouse, stylus, or microphone, as well as one or more output devices, such as a monitor, touch screen, speakers, or a printer.

The external system 160 sends underlying data 162 to the page maker 140 when requested and notifies the central controller when the underlying data 162 that is maintained has changed. The external system 160 may be implemented using, for example, a general-purpose computer capable of responding to and executing instructions in a defined manner, a personal computer, a special-purpose computer, a workstation, a server, a database, a device, a component, or other equipment or some combination thereof capable of responding to and executing instructions.

The external system 160 may receive instructions from, for example, a software application, a program, a piece of code, a device, a computer, a computer system, or a combination thereof, which independently or collectively direct operations, as described herein. The instructions may take the form of one or more data management programs that allow the external system 160 to store and communicate data. The instructions may be embodied permanently or temporarily in any type of machine, component, equipment, storage medium, or propagated signal that is capable of being delivered to the central controller 110.

Further, the external system 160 includes a communications interface (not shown) used by the communications programs to send communications to the central controller 110. The communications may include web pages, e-mail, audio data, video data, general binary data, or text data (e.g., encoded in American Standard Code for Information Interchange (ASCII) format).

The client information displays 170 display the formatted data maintained by the external system 160. Each client information display 170 shows the pages specified in the rotation set that is assigned to the client information display 170 and that is received from the sender 130 in the central controller 110. Specifically, the rotation set is received by a push receiver 172 in the client information display 170. The push receiver 172 is a module that is connected to a corresponding subscriber 134 in the central controller 110 and that waits for the corresponding subscriber 134 to send a new rotation set. When the push receiver 172 receives a new rotation set, the push receiver 172 passes the rotation set to a frameset controller 174. The frameset controller 174 reads the rotation set and controls the pages shown by a display screen 176. The frameset controller 174 displays each page in the rotation set on the display screen 176 for the amount of time specified in the rotation set before displaying the next page. When the frameset controller 174 instructs the display screen 176 to load a page, a cache 178 associated with the browser on the client information display 170, which stores the pages that have recently been loaded, is checked for the page. If the page is present in the cache 178, the page may be retrieved from the cache 178 instead of from the central controller 110.

The client information displays 170 may be distributed geographically and may be connected to the network 180 through various communication mediums, such as a modem connected to a telephone line (using, for example, serial line internet protocol (SLIP) or point-to-point protocol (PPP)) or a direct internetwork connection (using, for example, transmission control protocol/internet protocol (TCP/IP)). Each of the client information displays 170 may be implemented using, for example, a general-purpose computer capable of responding to and executing instructions in a defined manner, a personal computer, a special-purpose computer, a workstation, a server, a 3G mobile phone, a WAP phone, a PDA, a device, a component, or other equipment or some combination thereof capable of responding to and executing instructions.

Client information displays 170 may receive instructions from, for example, a software application, a program, a piece of code, a device, a computer, a computer system, or a combination thereof, which independently or collectively direct operations, as described herein. The instructions may take the form of one or more communications programs that facilitate the transfer and display of information on client information displays 170. For instance, such communications programs may include web browser programs, e-mail programs, instant messaging (IM) programs, and file transfer protocol (FTP) programs. The instructions may be embodied permanently or temporarily in any type of machine, component, equipment, storage medium, or propagated signal that is capable of being delivered to the client systems 102.

The client information displays 170 include a communications interface (not shown) used by the communications programs to send communications through the network 180. The communications may include web pages, e-mail, audio data, video data, general binary data, or text data (e.g., encoded in American Standard Code for Information Interchange (ASCII) format). The client information displays 170 also may include one or more input devices, such as a keyboard, mouse, stylus, or microphone, as well as one or more output devices, such as a monitor, touch screen, speakers, or a printer.

In one implementation, the client information displays 170 may be any type of device with a processor and a display screen that is capable of running a browser that operates in accordance with standard DHTML without any additional client applications, applets, or plug-ins. Rotation sets, in the form of HTML, XML, or streams, for example, may be delivered to browser clients or web devices representing the client information displays 170 by the central controller 110. Such an implementation allows the management and control of the client information displays 170 to remain centralized and also provides a convenient way to maintain security using conventional security protocols that are compatible with existing browser technology. Enhanced security may be implemented by plug-ins or in a number of other ways. Plug-ins would need to be implemented on the client and the server. Enhanced security may also be implemented using hardware controlled via the network provider, or within the code controlling the display of the pages. Any other desired security solution may also be used.

The network 180 connects the client information displays 170 to the central controller 110. The network 180 typically includes a series of portals interconnected through a coherent system. Examples of the network 180 include the Internet, Wide Area Networks (WANs), Local Area Networks (LANs), analog or digital wired and wireless telephone networks (e.g. a Public Switched Telephone Network (PSTN)), an Integrated Services Digital Network (ISDN), or a Digital Subscriber Line (xDSL)), or any other wired or wireless network. The network 180 may include multiple networks or subnetworks, each of which may include, for example, a wired or wireless data pathway.

In some implementations, the information display system 100 may include a site cache 190. The site cache 190 may be located remotely from the central controller 110 and may be connected to and in the vicinity of multiple client information displays 170. The site cache 190 stores the pages that have been viewed by one or more client information displays 170. Pages stored in the site cache 190 may then be loaded in lieu of requesting the same pages from the central controller 110. Use of the site cache 190 may save the central controller 110 from repeatedly creating and/or transferring a particular page that is used by multiple different client information displays 170.

The site cache 190 may be implemented using, for example, a general-purpose computer capable of responding to and executing instructions in a defined manner, a personal computer, a special-purpose computer, a workstation, a server, a device, a component, or other equipment or some combination thereof capable of responding to and executing instructions. The site cache 190 may receive instructions from, for example, a software application, a program, a piece of code, a device, a computer, a computer system, or a combination thereof, which independently or collectively direct operations, as described herein. The instructions may take the form of one or more communications programs that facilitate the storage and transfer of information. The instructions may be embodied permanently or temporarily in any type of machine, component, equipment, storage medium, or propagated signal that is capable of being delivered to the site cache 190. The site cache 190 may include a communications interface (not shown) used by the communications programs to send communications through the network 180. The communications may include web pages, e-mail, audio data, video data, general binary data, or text data (e.g., encoded in American Standard Code for Information Interchange (ASCII) format).

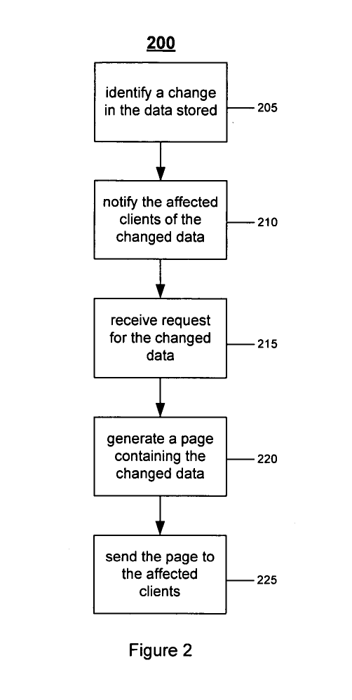

FIG. 2 is a flow diagram of a process 200 for displaying information on a distributed display system. First, a change in the information to be displayed is identified (step 205). The identification may occur when a signal indicating the data that has changed is received from a database that maintains the underlying data. A set of one or more clients that display the data that has been changed are identified and notified (step 210). The clients may be identified by querying configuration data that specifies the information displayed by each client. In one possible implementation, only the clients that display the changed data are notified of the change. The notification may be in the form of a new list of pages to display.

In response to the notification, each client may submit a request for the changed data in the form of a request for new pages that contain the changed data (step 215). After receiving the request, a page containing the changed data is generated (step 220). To generate a new page, the structure of the new page, including the underlying data on the pages and the layout of the data on the page, is identified. After identifying the structure, the changed data can be formatted and assembled to create the new page. The new page is then sent to the clients that requested the new page (step 225).

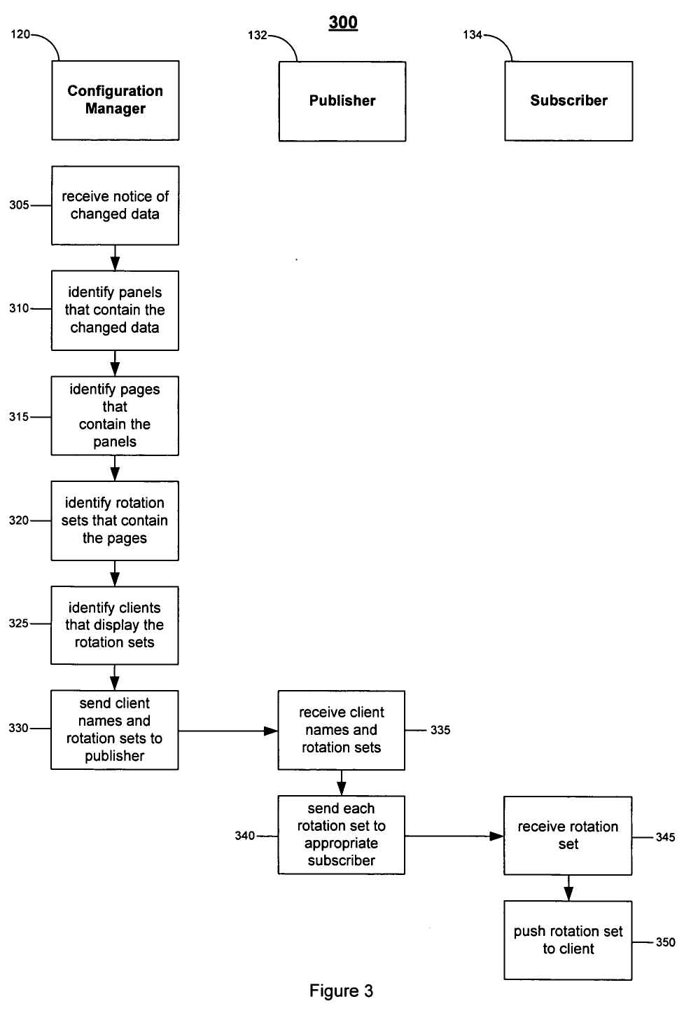

FIG. 3 is a signaling and flow diagram of a process 300 for notifying clients of a change in the data being displayed by an information display system, such as the system 100 of FIG. 1. The process 300 involves communication between a configuration manager 120, a publisher 132, and a subscriber 134. First the configuration manager receives notice of the changed data from an external system (step 305). The external system signals the central controller that the data to be displayed has changed through the API of the central controller. The external system also uses the API to notify the central controller how the data to be displayed has changed. The details from the external system about how the data to be displayed has changed are passed to the configuration manager 120.

The configuration manager 120 then identifies the panels that need to be regenerated by referring to XML configuration documents (step 310). The XML configuration documents contain information on the data that is used to create the panels that are displayed. The configuration documents can be parsed to identify which panels contain changed data. Next, the pages that contain the panels are identified by the configuration manager (step 315). The XML configuration documents also specify the panels that make up each page, and parsing the XML configuration documents allows the configuration manager 120 to identify the pages affected by the change in data. The configuration manager then identifies the rotation sets that contain the pages affected by the change in data (step 320). The affected rotation sets can be retrieved by querying the XML configuration documents that specify which pages are in each rotation set. The client information displays that display the rotation sets that include changed pages are then identified by querying the XML configuration documents (step 325).

The configuration manager 120 sends the names of the client information displays affected by the change in data and the rotation sets to be displayed by the affected client information displays to the publisher 132 (step 330). The URLs contained within the rotation sets are updated by the configuration manager 110 as necessary to reflect the changed data. The URL of a page to be displayed generally indicates to the central controller 110 the data to be retrieved when a request for the URL is received. When the data changes, a new URL is assigned to the page. The configuration manager 120 includes metadata defining the page associated with the URL. The content metadata, for example, identifies which data from the external system is included in the page. Thus, when a request for the URL is subsequently received at the central controller 110, a new page that includes the changed data can be constructed by requesting the latest data from the external system, as indicated by the content metadata associated with the URL. In some cases, the underlying data may have changed again since the notification sent at step 305. By requesting the latest data from the external system in response to receiving a request for the URL, any such changes will be incorporated into the new page. The rotation sets may be specified in an XML format that identifies the pages within the rotation set. The publisher 132 receives the client names and the rotation sets sent by the configuration manager 120 (step 335). The publisher sends each rotation set to the subscriber that corresponds to the client information display that is to display the rotation set (step 340). Each subscriber that was sent a rotation set by the publisher receives the rotation set (step 345). The subscribers 134 send the rotation set, along with instructions for parsing and interpreting the rotation set, through the network to the corresponding client information displays (step 350). The new rotation set may be transferred through the network from the central controller to the client information displays using hypertext transfer protocol (HTTP), or any other network communication protocol. The arrival of a new rotation set informs the client information displays that the data to be displayed has changed and, thus, allows the client information displays to load and display the pages in the new rotation set.

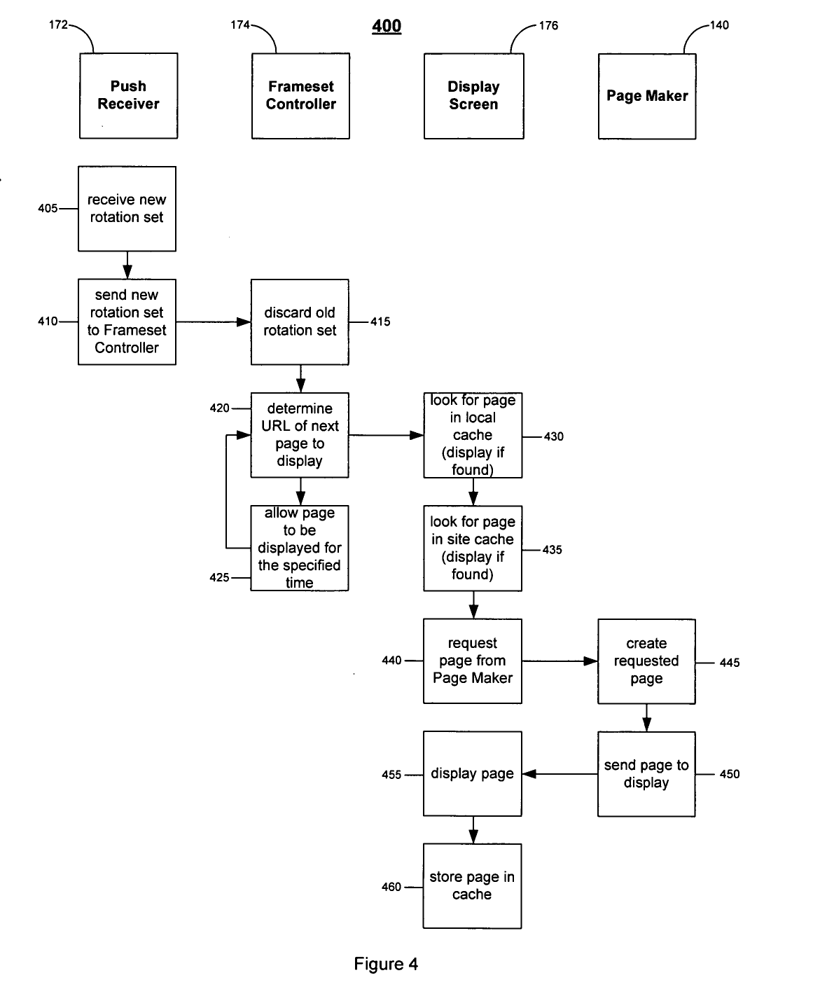

FIG. 4 is a signaling and flow diagram of a process 400 for displaying the pages in a rotation set on a display, such as the client information display 170 of system 100 of FIG. 1. The process 400 involves communication between a push receiver 172, a frameset controller 174, a display screen 176, and a page maker 140. The process 400 starts when the push receiver 172 receives a new rotation set from the subscriber on the central controller that is associated with the push receiver 172 (step 405). The push receiver 172 sends the new rotation set to the frameset controller 174 and waits for another new rotation set (step 410).

After receiving a new rotation set, the frameset controller 174 discards the rotation set that has been used (step 415). The frameset controller 174 executes the instructions sent with the new rotation set to access the new rotation set and to determine from the new rotation set the URL of the next page to be displayed (step 420). The frameset controller 174 may receive JavaScript code that controls which URLs to load in the display frame 174, based on the XML rotation sets received in the push receiver frame 172. To determine the URL, for example, the frameset controller 174 examines each successive page element in a received XML document that specifies the rotation set. The “url” attribute of each page element specifies the location of the page to be displayed. The frameset controller 174 loads and displays, on the display screen 176, the page at the specified URL. The frameset controller 174 waits for the amount of time specified by the “delay” attribute of the current page element of the rotation set, during which the display screen 176 continues to display the page (step 425). After the specified amount of time, the frameset controller 174 accesses the next page element in the rotation set and identifies the URL of the next page to be displayed (step 420), and frameset controller 174 loads and displays the next page on the display screen 176 (step 425). The display sequence loops through the pages in the rotation set until a new rotation set is received.

When a page from the rotation set is loaded, the display screen 176 first checks for the page in a local cache (step 430). The local cache may be a cache associated with a browser on the client information display 170. Pages are loaded into the cache after being retrieved from the central controller. On subsequent requests for the page, if the page has not expired or been deleted from the local cache, based on standard cache expiry criteria, the page is retrieved from the local cache. If the page is found in the local cache, the display screen 176 displays the page until the frameset controller 174 determines that a new page should be displayed.

If the page is not found in the local cache, a site cache, if present, is also checked for the requested page (step 435). The site cache may store pages that have been requested by any one of a set of client information displays 170 that are geographically or logically associated with one another. Pages are also loaded into the site cache while being retrieved from the central controller and displayed. Generally, the pages are routed through the site cache on the way from the central controller to the display, so the page is saved as it passes through the site cache. On subsequent requests for the page, if the page has not expired from the site cache, the page is retrieved from the site cache. If the page is found in the site cache, the display screen 176 displays the page until the frameset controller 174 determines that a new page should be displayed. In general, if the page is not found in the local cache, a request for the page is sent to the URL associated with the page. The request may be routed through a site cache, if present, which may intercept the request to determine whether the requested page is stored in the site cache. If so, the site cache may respond to the request by providing the requested page. If the requested page is not stored in the site cache, however, the site cache may forward the request to the URL to which the request was originally addressed. Finding the page in either the local cache or the site cache reduces network traffic and server load by preventing the central controller from repeatedly creating and transmitting the same page.

When not found in the local or site cache due to expiring or not being previously loaded, the page is requested from the page maker 140 in the central controller (step 440). The page maker 140 creates the requested page (step 445) and sends the requested page back to the display screen 176 that requested the page (step 450). The display screen 176 that requested the page displays the page for the amount of time specified in the rotation set (step 455). The page is also stored in the local and site caches (step 460).

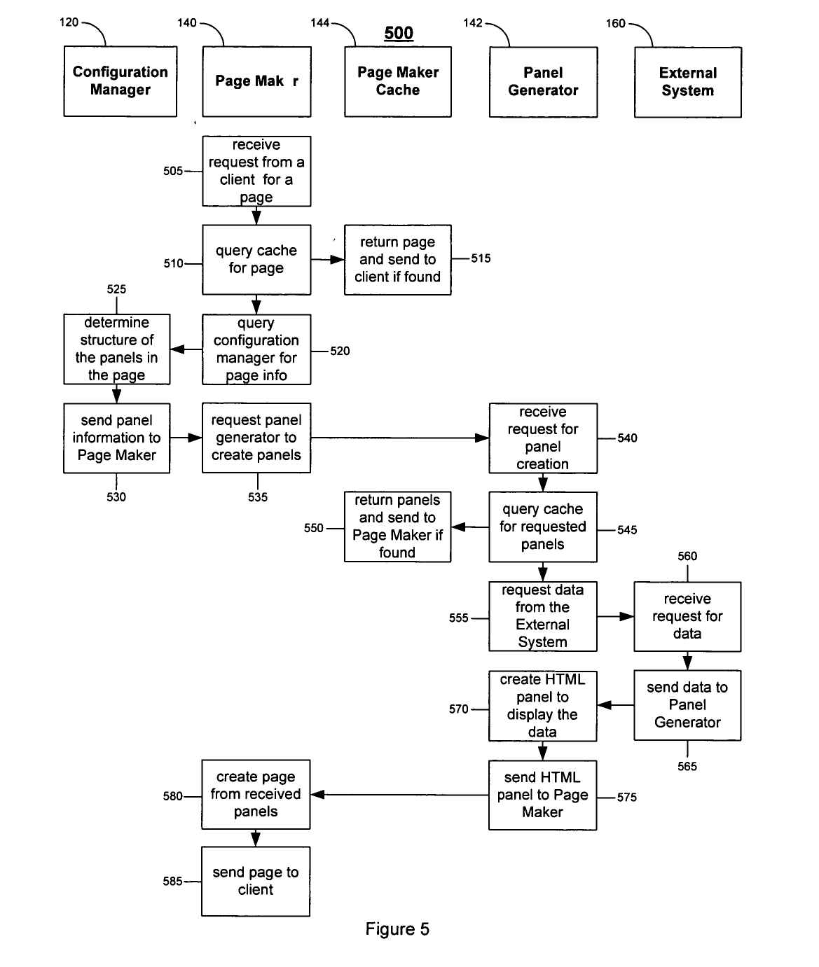

FIG. 5 is a signaling and flow diagram of a process 500 for creating a page on an information server, such as the central controller 110 of the information display system 100 of FIG. 1. A page is generally created in response to a request from a display device, such as the client information display 170 of the information display system 100 of FIG. 1. The request may be in the form of a hypertext transfer protocol (HTTP) request and may include a URL associated with the page and an identifier of the display device that sent the request. The process 500 involves a configuration manager 120, a page maker 140, a page maker cache 144, a panel generator 142, and an external system 160. The page maker 140 receives a request for a page to be displayed (step 505). The page maker 140 queries the page maker cache 144 for the requested page (step 510). The page maker cache 140 returns the page if the page is found (step 515). When found in the page maker cache 144, the page is sent to the client, and the page creation process 500 stops. Finding the page in the page maker cache 144 saves the page maker 140 from identifying the structure of the page, retrieving the data from the external server, and constructing the page.

If the page is not found in the page maker cache 144, the page maker 140 queries the configuration manager for data specifying the contents and structure of the page (step 520). In response to the query from the page maker 140, the configuration manager 120 uses configuration data to identify the panels in the requested page, the data from the external system necessary to create the panels, and the arrangement of the panels in the requested page (step 525). The page specification data is sent to the page maker 140 (step 530).

For each panel in the page, the page maker 140 sends a request for the panel to a panel generator 142 (step 535). The request may include data from the configuration manager 120 that specifies how to create the panel. A panel generator 142 then receives the request for panel generation (step 540) and checks the page maker cache 144 for the panel to be generated (step 545). Even in situations where the page has not previously been created, and thus is not stored in the page maker cache 144 the panel may have been previously created and stored in the page maker cache 144 if, for example, the same panel was previously included on a different page. The page maker cache 144 returns the panel if found (step 550), and the panel generator 142 does not have to create the panel by retrieving the data for the panel from the external system 160 and formatting the data. The page maker 140 may identify whether pages and panels are stored in the page maker cache 144 using a unique naming convention. In particular, the page maker cache 144 may store pages using a filename that can be determined from the received URL. Thus, when a request for a page is received, the page maker 140 can identify the filename for the page and determine if a file with the identified filename exists in the page maker cache 144.

If the panel is not found in the page maker cache 144, the panel generator 142 queries the external system 160 for the data needed to create the panel (step 555). The external system 160 receives the request (step 560) and sends the requested data to the panel generator 142 (step 565). Using the data received from the external system 160, the panel generator 142 creates the panel (step 570). In one possible implementation, the panel may be represented by HTML code, although other techniques for defining or constructing the panel may be used. The HTML code is sent to the page maker 140 (step 575). The page maker 140 collects the HTML code representing all of the panels created by the different panel generators 142 and constructs the full page from the individual panels (step 580). The page maker 140 uses the data from the configuration manager 120 specifying the layout of the panels on the page when creating the full page. The page is finally sent back to the client information display that originated the request (step 585).

The described systems and techniques allow for central control and management of a distributed display system, which results in easier deployment and maintenance. By pushing changes to client devices as they occur, the frequency of requests for pages may be significantly reduced by taking full advantage of caching, which results in decreased network traffic and server load and reduces demands on client processing resources. When the pages to be displayed are found in the local or site caches, the client information displays do not have to send requests for pages across the network to the central controller, and the central controller does not have to create the pages. The page maker cache has similar effects. When pages from the page maker cache are used, the central controller does not have to access the external system for data or format the data into the page, which further reduces the demands on the central controller and the external system.

A number of embodiments of the invention have been described. Nevertheless, it will be understood that various modifications may be made without departing from the spirit and scope of the invention. For example, although various types of data used to implement the techniques are described as being in XML or HTML format, data in other formats may be used to define panels, pages, rotation sets, assignments of rotation sets to particular displays, structures, content, and the like. In addition, although the processes described and illustrated in FIGS. 3-5 refer to the information display system 100 of FIG. 1, the processes may be implemented without necessarily requiring the specific components of the information display system 100 of FIG. 1. Accordingly, other implementations are within the scope of the following claims.

1. A method for displaying information on a set of displays, the method comprising:
identifying a change in data displayed by a set of clients;
notifying the set of clients of a change to the displayed data;
receiving a request for a page containing the changed data in response to the notification;
generating a page containing the changed data; and
sending the page containing the changed data to the set of clients.

2. The method of claim 1 wherein each client is assigned a rotation set comprising a list that identifies pages to be displayed by the client, the method further comprising:
identifying the page that contains the changed data;
identifying at least one rotation set that identifies the page containing the changed data; and
identifying at least one client that displays the at least one identified rotation set.

3. The method of claim 2 wherein the rotation set specifies a uniform resource locator for at least one page to be displayed by the client to which the rotation set is assigned.

4. The method of claim 2 wherein the rotation set specifies an amount of time for which the at least one page is to be displayed by the client to which the rotation set is assigned.

5. The method of claim 2 wherein notifying a set of clients of the change to the displayed data comprises sending at least one rotation set to the set of clients, with the pages identified by the at least one rotation set reflecting the change in the displayed data.

6. The method of claim 5 wherein the at least one rotation set is sent to the set of clients in response to identifying the change in the displayed data.

7. The method of claim 5 wherein hypertext transfer protocol (HTTP) is used to send the at least one rotation set to the set of clients.

8. The method of claim 5 further comprising sending, to the set of clients, instructions for each client to request pages that contain changed data in response to receiving a rotation set.

9. The method of claim 5 further comprising sending, to the set of clients, instructions for each client to display the pages identified by a received rotation set at least until the client receives a new rotation set.

10. The method of claim 9 wherein the instructions comprise portable, platform independent code.

11. The method of claim 9 wherein hypertext transfer protocol (HTTP) is used to send, to the set of clients, the instructions for each client to display the pages identified by a received rotation set.

12. The method of claim 2 wherein each page comprises a plurality of panels and identifying the page that contains the changed data comprises:
identifying a panel that contains the changed data; and
identifying the page that contains the identified panel.

13. The method of claim 12 wherein the panel that contains the changed data and the page that contains the identified panel are identified using XML code.

14. The method of claim 2 wherein the rotation set is defined in an extensible markup language (XML) document.

15. The method of claim 2 wherein the page that contains the changed data, the at least one rotation set that identifies the page containing the changed data, and the at least one client that displays the at least one identified rotation set are identified using XML code.

16. The method of claim 1 wherein identifying a change in the displayed data comprises receiving an indication of the change in the displayed data.

17. The method of claim 1 further comprising storing the page containing the changed data for access by a plurality of different displays.

18. The method of claim 1 wherein the page containing the changed data includes a plurality of panels, the method further comprising:
identifying at least one panel that contains the changed data; and
identifying at least one page that contains the at least one identified panel.

19. The method of claim 1, wherein generating the page containing the changed data comprises defining the page using hypertext markup language (HTML).

20. The method of claim 1 further comprising retrieving the page containing the changed data from a cache in response to receiving the request, wherein generating the page containing the changed data is performed in response to a previously received request for the page containing the changed data.

21. The method of claim 1 wherein the page containing the changed data includes a plurality of panels, the method further comprising:
identifying at least one panel that contains the changed data;
retrieving the changed data; and
generating the at least one identified panel using the changed data, wherein generating the page containing the changed data is performed using the at least one identified panel.

22. The method of claim 21 further comprising retrieving the at least one panel containing the changed data from a cache in response to receiving the request, wherein generating the at least one panel containing the changed data is performed in response to a previously received request for the at least one panel containing the changed data.

23. The method of claim 21 wherein a name of the page containing the changed data specifies the changed data to be retrieved.

24. The method of claim 1 wherein the request complies with the hypertext transfer protocol.

25. The method of claim 1 further comprising displaying the page containing the changed data in a web browser.

26. A method for displaying information on a display device, the method comprising:
receiving a rotation set comprising a list identifying pages to be displayed;
determining if each page identified in the rotation set is stored in a cache associated with the display device;
retrieving, from the cache, pages that are stored in the cache; sending at least one request for pages that are not stored in the cache to a remote server;
receiving the requested pages in response to the at least one request;
storing the received pages in the cache; and
displaying each page, wherein the pages are retrieved from the cache and displayed in a repeating sequence until a new rotation set is received.

27. The method of claim 26, wherein the rotation set further indicates a time period, corresponding to each identified page, for displaying the identified page, and each page is displayed for the time period corresponding to the page.

28. The method of claim 26 wherein the rotation set comprises an extensible markup language (XML) document.

29. The method of claim 26 wherein the at least one request is sent using hypertext transfer protocol (HTTP).

30. The method of claim 26, wherein displaying the page comprises displaying the page using a web browser.

31. A system for displaying information on a set of displays comprising:
a database for storing data to be displayed; and
at least one server adapted to:
respond to a change in the stored data to be displayed by identifying at least one client adapted to display the stored data and notifying the at least one client of the change in the stored data;
receive a request for a page containing the changed data;
generate the requested page; and
send the page to a client that displays the page in response to the received request.

32. The system of claim 31, wherein the database notifies the server when the data to be displayed has changed.

33. The system of claim 31, wherein the server comprises a configuration management module adapted to identify rotation sets that include at least one page affected by the change in the stored data, with each rotation set comprising a list of pages to be displayed by a client to which the rotation set is assigned.

34. The system of claim 33 wherein the server is adapted to notify the at least one client by sending, to the at least one client, a rotation set that includes at least one page affected by the change in the stored data.

35. The system of claim 34 further comprising a local cache associated with the at least one client, wherein each local cache stores pages identified in the rotation set for the associated client and the associated client displays each page identified in rotation set assigned to the client until the client receives a rotation set that does not identify the page.

36. The system of claim 33 wherein the configuration management module is further adapted to store data regarding the content and layout of the at least one page.

37. The system of claim 31 wherein the server is further adapted to maintain an open connection with each client, with the notification of the change in the stored data sent using the open connection.

38. The system of claim 31 wherein the server further comprises a cache for storing previously requested pages and the server is adapted to retrieve, from the cache, requested pages stored in the cache to send to the client that displays the page.

39. The system of claim 31 wherein the server further comprises a page maker module adapted to generate the requested pages using the changed data in the database and using formatting data defining the content and layout of the pages.

40. The system of claim 39 wherein the page maker module includes at least one panel generator for generating panels, with each page constructed from a plurality of panels as defined by the formatting data.

41. The system of claim 31, further comprising a site cache that stores pages displayed by a plurality of different clients, wherein the site cache is adapted to respond to a request for a page stored in the site cache by sending the requested page to a client that requested the page.

42. An article comprising a machine-readable medium storing instructions for causing one or more processors to perform operations comprising:
receiving a list of pages to be displayed;
retrieving, from a local cache, pages in the list that are stored in the local cache;
requesting, from a remote server, pages in the list that are not stored in the local cache;
receiving pages from the remote server;
storing the received pages in the local cache;
displaying the pages in the list in a repeating sequence, using the pages stored in the local cache, until a new list of pages is received.

43. The article of claim 42 wherein the list of pages comprises a uniform resource locator (URL) associated with each page and a specific page is requested from the remote server using a hypertext transfer protocol (HTTP) request containing the URL associated with the specific page.

44. The article of claim 42 wherein the machine-readable medium stores instructions for causing one or more processors to perform further operations comprising displaying each page in the list of pages for a predetermined amount of time in each repetition of the repeating sequence.

45. The article of claim 42 wherein the machine-readable medium stores instructions for causing one or more processors to perform further operations comprising:
receiving a new list of pages;
identifying pages in the new list that differ from the pages stored in the local cache; and
requesting the identified pages from the remote server.

46. The article of claim 42 wherein an extensible markup language (XML) document contains the list of pages.
